(19) United States
(12) Patent Application Publication
(10) Pub. No.: US 2006/0036864 A1
(43) Pub. Date: Feb. 16, 2006

(54) Digital camera with image authentication

(76) Inventors: Kenneth A. Parulski, Rochester, NY (US); Majid Rabbani, Pittsford, NY (US); Martin A. Parker, Rochester, NY (US)

Correspondence Address: Pamela R. Crocker;Patent Legal Staff, Eastman Kodak Company, 343 State Street, Rochester, NY, 14650-2201, US

(21) Appl. No.: 11/253,854

(22) Filed: Oct. 18, 2005

Related U.S. Application Data
(63) Continuation of application No. 09/473,522, filed on Dec. 28, 1999.

(51) Int. Cl. H04L 9/00

(52) U.S. Cl. 713/176

(57) ABSTRACT

A digital camera having a public key encryption system to establish the authenticity of digital images created by the camera, wherein the private key/public key pair is produced within the digital camera using an algorithm which ensures that it is unique, rather than being produced on a separate computer and uploaded to the camera. The private key is stored in a memory within the digital camera, so that it cannot be discovered.

### CROSS REFERENCE TO RELATED APPLICATIONS

This is a continuation of pending U.S. application Ser. No. 09/473,522, filed Dec. 28, 1999, by Kenneth A. Parulski, entitled DIGITAL CAMERA WITH IMAGE AUTHENTICATION.

### FIELD OF THE INVENTION

The present invention relates to the field of electronic photography, and in particular, to the authentication of images captured by a digital camera.

### BACKGROUND OF THE INVENTION

Digital images produced by digital cameras can be easily manipulated, for example, to add or remove objects from a scene. This makes the authenticity of any digital image questionable when used, for example, as legal evidence at a crime scene. Cameras performing “image authentication” may use some type of “digital signature” that indicates whether the image has been modified. Approaches employing the well known public key encryption system are described in U.S. Pat. No. 5,499,294, issued Mar. 12, 1996 to Friedman and in commonly-assigned U.S. Pat. No. 5,898,779, issued Apr. 27, 1999 to Squilla et al., the disclosure of which is herein incorporated by reference. The use of the public key encryption system to ensure that the digital signature is not altered requires that the camera utilize a private key to generate the digital signature, which can later be authenticated using a corresponding public key.

One major issue with this approach is proving that the private key remained private from the moment the camera was manufactured, and could never have been compromised and later misused in order to digitally sign an altered picture. A clever defense attorney could call into question whether a biased law enforcement agency could have somehow obtained the private key for the camera they allegedly used to photograph incriminating evidence, and misused it. Some prior art cameras use private keys that are separately generated (e.g., by a separate computer) and provided to the camera by uploading firmware including the private key to the camera. In these cases, the manufacturer or in some cases, even the user, has some record (e.g., in the separate computer) of the private key. Thus, there is no way to absolutely prove that the private key was not somehow “leaked” and used to alter an image captured by the camera.

Another shortcoming of the prior art approaches of employing public key encryption systems to authenticate images is that the manufacturer must bear the cost of securely generating the public/private key pairs and loading them in the camera.

Current owners of digital cameras may desire to add such a security feature to their cameras by loading the authentication software and private key into the existing camera's control system. A vulnerability of this system is the generation and uploading of the private key to the camera, which could be intercepted by a third party during the generation or uploading of the private key to the camera.

There is a need, therefore, to provide an improved public key encryption system for authenticating digital images captured by a camera in a way that reduces the chances that the private key used to create the digital signature in a digital camera can be discovered or compromised, and that relieves the manufacturer of the burden of generating and loading private keys in a secure manner.

### SUMMARY OF THE INVENTION

The above identified need is met according to the present invention by providing a digital camera having a public key encryption system to establish the authenticity of digital images created by the camera. The private key/public key pair is generated within the digital camera using an algorithm which ensures that it is unique, rather than being generated on a separate computer and uploaded to the camera. The private key is stored in a memory within the camera, so that it cannot be discovered. Because the private key is never generated or stored on a separate computer or transmitted to the camera over a separate interface, it is much more secure. This greatly reduces the risk that the private key will be compromised. Also, because the private-public key pair is generated internal to the camera, the manufacturer does not need to provide for the security of private key generation and loading of the private key into the camera.

### BRIEF DESCRIPTION OF THE DRAWINGS

FIG. 1 is a system block diagram showing a digital camera and a host computer useful in practicing the present invention;

FIG. 2 is a flow diagram illustrating the manufacture and use of the digital camera of FIG. 1 according to the present invention; and

FIG. 3 is a flow chart showing an algorithm for generating the private key/public key pair within the digital camera of FIG. 1 according to the present invention.

### DETAILED DESCRIPTION OF THE INVENTION

Because image authentication systems using public key encryption for image authentication are well known, the following description will be directed to the particularly unique elements and features of the present invention. Elements not specifically shown or described herein may be selected from those known in the art. Some aspects of the present invention may be implemented in software. Unless otherwise specified, all software implementation is conventional and within the ordinary skill in the programming arts.

The camera and system of the present invention enables a photographer or another to authenticate an image captured by the camera, to ensure that the image has not been modified. The camera and system accomplishes this by generating a private key/public key pair within the digital camera, rather than on a separate computer, and storing the private key in a nonvolatile memory within the digital camera. This ensures that there is never a record of any type external to the digital camera that includes the private key. Because the private key is not made available to anyone at any time outside of the camera, the chances of it being compromised are substantially reduced.

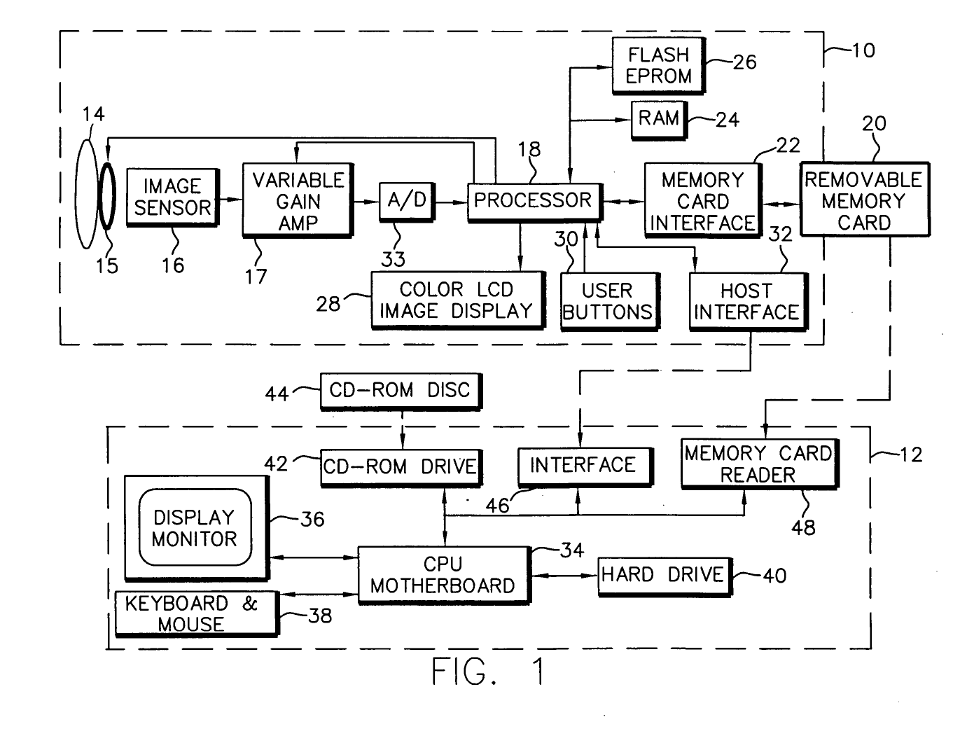

A system block diagram is shown in FIG. 1, and includes a portable digital camera 10 and a host computer 12. The camera 10 includes a lens 14, which may be a motor driven zoom lens with automatic focusing, a shutter/aperture 15, an image sensor 16, a variable gain amplifier 17, an analog-to-digital (A-to-D) converter 33, a processor 18, a removable memory card 20 received in a memory card interface 22, random access memory (RAM) 24, and Flash memory 26. The digital camera 10 can also include a color liquid crystal display (LCD) 28, a number of user input buttons 30, and a host computer interface 32, such as a universal serial bus (USB). The image sensor 16 is covered with a color filter array (CFA) (not shown), such as described in commonly assigned U.S. Pat. No. 3,971,065 to Bayer, the disclosure of which is herein incorporated by reference. The processor 18 converts the raw digital data from the image sensor 16, which is temporarily stored in RAM memory 24, into interpolated color data using an algorithm such as the one described in commonly assigned U.S. Pat. No. 5,506,619 to Adams et al., entitled “Adaptive color plan interpolation in single sensor color electronic camera,” the disclosure of which is herein incorporated by reference. The interpolated color image data is color corrected, sharpened, and compressed using the well-known JPEG compression algorithm, and stored within an image file, for example, the Exif version 2.1 image file, on the removable memory card 20. The Exif image format is defined in “Digital Still Camera Image File Format Standard, Exchangeable image file format for Digital Still Camera: Exif,” JEIDA-49-1998, June 1998 by the Japan Electronics Industries Development Association (JEIDA). Note that since JPEG compression is a lossy compression algorithm, it is impossible to exactly reconstruct the raw image sensor data by decompressing and processing the JPEG compressed image data within the Exif image file.

The processor 18 includes a real-time clock (not shown) which provides digital date/time information. This date/time “metadata,” as well as other metadata, for example, the zoom lens focal length setting, and the exposure time and f/# values used by the shutter/aperture 15 when capturing a particular picture, are recorded in the image file, using the TIFF tags described in the Exif document cited above. Additional metadata which is the same for all images, such as the copyright owner or camera owner, can also be downloaded from the host computer 12 to the digital camera 10 and stored in the Flash memory 26. This metadata can also be copied into the appropriate TIFF tags within the Exif image file. Other types of metadata, such as a digital audio recording or global positioning system (GPS) information could be obtained from a microphone input (not shown) or GPS receiver (not shown) built into or attached to the digital camera 10 and stored as part of the Exif image file, within the appropriate TIFF tags or application segments, as described in the Exif document cited above. Thus, each image file contains not only image data, but also a significant amount of metadata.

The digital camera 10 operates in the conventional manner, using the lens 14 to focus an image through the shutter/aperture 15 onto the image sensor 16, amplifying the analog image sensor signal by the variable gain amplifier 17 set to provide a normal gain level, converting the signals recorded by the image sensor 16 to digital signals in the A-to-D converter 33 to produce a digital image, processing the digital image in the processor 18, for example, to compress the image and place it in a standard format, and storing the image in the removable memory card 20. In addition, the digital camera 10 employs the processor 18 to create a digital signature for an image, or a portion of the image using a public key system and to attach the digital signature to the digital image, as disclosed in U.S. Pat. No. 5,898,779. The digital signature can be stored within an Exif version 2.1 image file by registering a TIFF tag for this purpose and including the TIFF tag and digital signature value within the Exif application segment at the beginning of the JPEG file.

The host computer 12, which can be a Personal Computer, includes, by way of example, a mother board 34 containing a power supply (not shown), a microprocessor (not shown), e.g., an Intel Pentium II™ processor, and memory (not shown) as is well known in the art. As shown in FIG. 1, the host computer 12 further includes a display monitor 36, operator interfaces such as a keyboard and mouse 38, a hard drive 40, a CD-ROM drive 42 for reading CD-ROM discs 44, an interface 46, such as a universal serial bus (USB), and a memory card reader 48 for reading the removable memory cards 20 from the digital camera 10. The host computer 12 operates in the conventional manner to receive and display digital images recorded by the digital camera 10. In addition, the host computer 12 can employ the public key to authenticate the digital signatures appended to the digital images, using the known prior art techniques. In the digital camera 10 according to the present invention, the public/private key pair is produced by the processor 18 in the digital camera 10, and the private key is securely stored in the Flash EPROM 26.

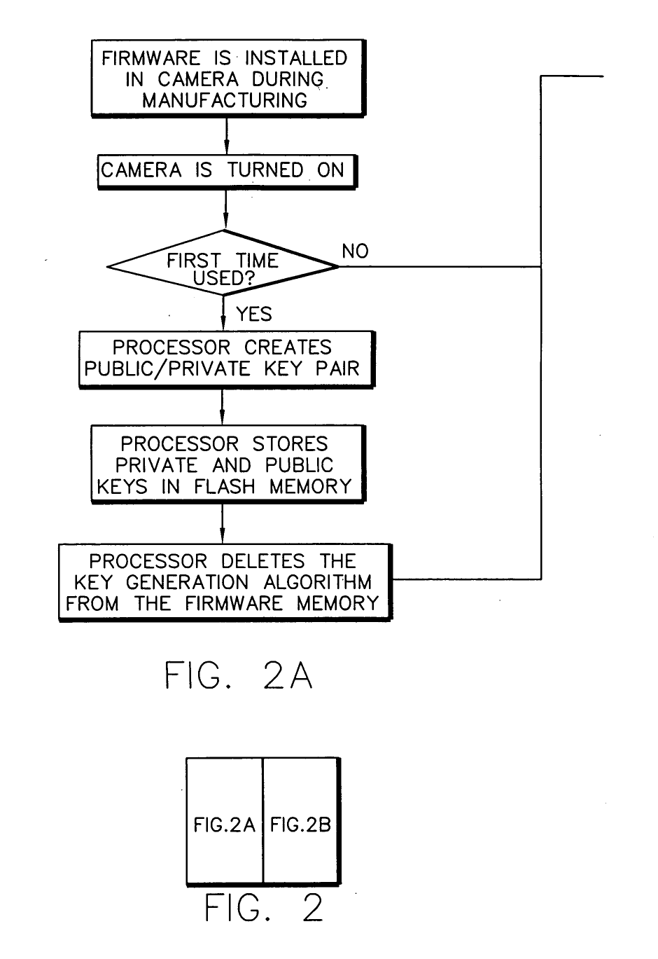

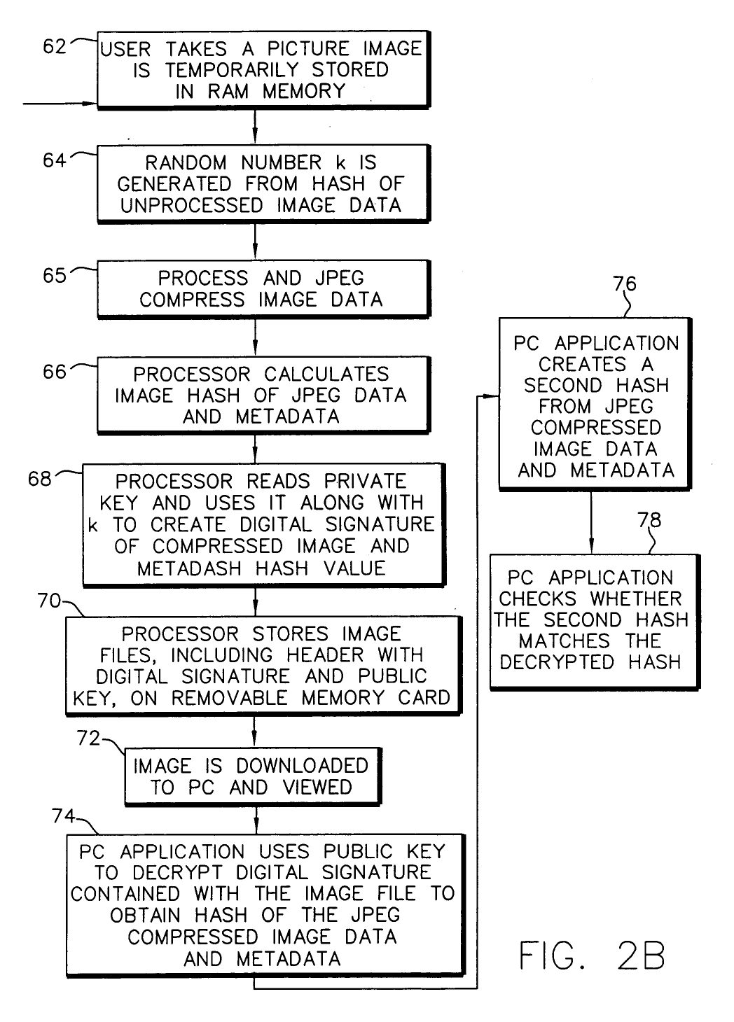

FIG. 2 is a flow diagram showing the steps in the manufacture and use of the digital camera 10 according to the present invention. During manufacture, the firmware for generating the public/private key pair is installed in the digital camera 10 (step 50). Alternatively, the camera firmware can be updated at some time after the digital camera 10 has been manufactured, for example, when the user purchases or receives “updated” camera firmware, for example, by obtaining a CD-ROM disc with the updated firmware, or by downloading the updated firmware from the internet. When the digital camera 10 is turned on (step 52), a check is made by the processor 18 to see if this is the first time the digital camera 10 has used this firmware (step 54). If this is the first time, the processor 18 creates the public/private key pair (step 56) and stores the private key in flash memory 26 (step 58). The processor 18 then deletes the key generation instructions from the firmware memory (step 60). The operation of the digital camera 10 then proceeds as follows. Each time the user takes a picture, the captured image is temporarily stored in RAM memory 24 (step 62). A random number k is produced from a hash of the unprocessed image sensor data (step 64). The processor 18 then processes the color image data to provide fully processed and JPEG-compressed image data (step 65). The processor 18 calculates a hash value of the JPEG compressed image data and the metadata that is to be stored in the image file (step 66), reads the private key from the Flash memory 26, and uses it along with the random number k to create a digital signature of the compressed image and metadata hash value (step 68) which is then also stored within the same image file. The processor 18 stores the image files, including the digital signature and public key, on the removable memory card 20 (step 70).

To view the image (step 72), either the removable memory card 20 can be placed in the memory card reader 48 and the digital image file read from the memory card 20, or the digital image file can be directly downloaded from the digital camera 10 into the host computer 12 via the USB interface 32,46. An application in the host computer 12 uses the camera's public key to decrypt the digital signature contained within the image file to obtain a hash of the JPEG compressed image data and the metadata that is stored within the image file (step 74). The application then creates a second hash from the JPEG compressed digital image data and the metadata that was stored within the image file (step 76), and checks to see whether this second hash matches the decrypted hash (step 78). If the hashes match, it is evidence that the digital image has not been modified since it was captured by the digital camera 10.

According to a preferred embodiment of the present invention, the digital signature generation is performed as specified in the Digital Signature Standard (DSS) and explained in Federal Information Processing Standards Publication (FIPS) PUB 186-1, dated Dec. 15, 1998. The DSS specifies a suite of algorithms that can be used to generate a digital signature. In particular, it discusses both the technique specified in ANSI X9.31 (the RSA algorithm) and the Digital Signature Algorithm (DSA) as options for digital signature generation. Preferably, the DSA algorithm is employed for digital signature creation.

The DSA makes use of the parameters p, q, g, k, x, and y, as specified in FIPS 186-1. The parameters p, q, and g are public and can be generated either inside the camera specific to each camera or can be generated outside the camera on a host computer and provided as constants supplied in the camera key generation firmware. The parameters p and q are generated according to the specification in Section 2.2 of FIPS 1186-1. In a preferred embodiment of the present invention, p is represented by a 768 bit value. Alternatively, any multiple of 64 bits between 512 bits and 1024 bits can be used. The value of q is restricted to be a 160 bit prime according to the requirements of the DSA standard. In a preferred application, the values for p, q and g are supplied as constants as part of the camera key generation firmware. Since p and q must be prime numbers, it is difficult to compute them using a simple algorithm in a short period of time within the camera.

The parameter x is the private key of the camera and is a randomly or pseudo-randomly generated integer with the restriction that 0<x<q. The parametery is the camera's public key. According to the present invention, x and y are generated inside the camera after installation of the camera firmware, and only the parameter y is made public, while the parameter x is never revealed.

In a preferred embodiment, the public key of the camera is included in the digital image file (e.g., in the image file header as indicated in step 70 of FIG. 2), that represents the image captured by the camera so that a quick authentication can be performed without the necessity of consulting another source to obtain the public key. However, if the public key associated with a given camera is not certified at the time of key generation, it is possible for an imposter to alter the image and then sign the altered image with a new private key (generated by the imposter) and include the matching public key in the image file.

In an alternative embodiment of the present invention, the public key y associated with a given camera is also certified by a certification authority and stored for future reference. The certification authority could be, for example, the camera manufacturer or an independent certification authority such as VeriSign® available at WWW.verisign.com, or even the owner, depending on the level of security desired. In the event that the certification authority is independent from the manufacturer, the manufacturer can send the camera to the certification authority, where it is activated to generate the public/private key pair. The certification authority then records the public key generated by the camera, and forwards the camera to the end user. Alternatively, the camera user generates the public/private key pair and requests a certificate from the certification authority by sending the public key to the certification authority via a secure internet communication.

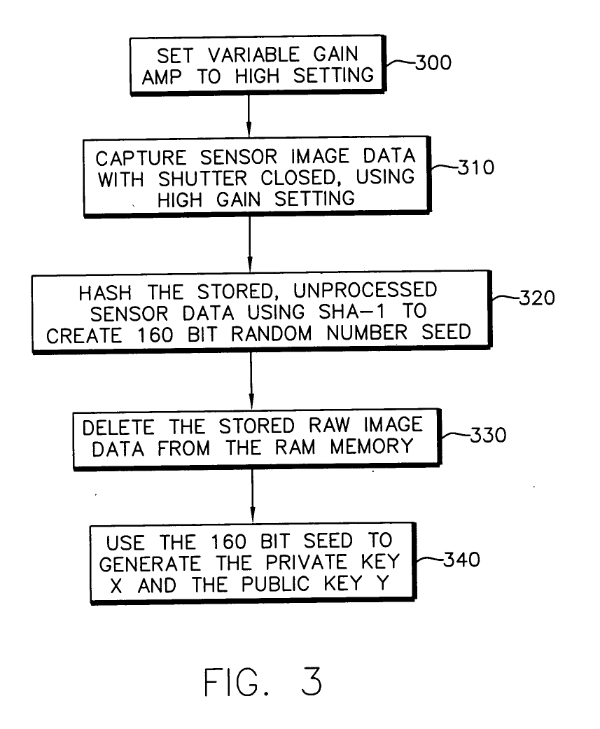

FIG. 3 is a flow chart depicting step 56 of FIG. 2 in greater detail. In particular, FIG. 3 depicts how the private key/public key pair is created within the digital camera 10 in a way that ensures that it is unique and that the same algorithm cannot be run again on a separate camera or computer in order to create the same key pair.

It is important to generate the private key x inside the camera using a process that cannot be duplicated at a later time, otherwise, the camera security would be compromised. The first steps in the generation of the keys provide a random seed. The random seed needed for the generation of x can be provided in a variety of ways, for example, using a pseudo-random number generation algorithm that uses as an input a time-dependent internal state of the camera microprocessor (such as the output of an internal clock) at the time of the key generation.

In a preferred approach depicted in FIG. 3, the random seed is generated by processing an image captured from the image sensor, which provides random dark field image data. In step 300, the variable gain amplifier 17 is set to provide a high level of gain. In step 310, an image is captured with the shutter 15 closed, and the raw CFA data from the image sensor 16 is temporarily stored in the RAM 24. The stored CFA data is composed of amplified dark current noise, so that each pixel value has a random noise level. In step 320, the entire raw sensor image (or alternatively, a portion of the image) is then hashed down to 160 bits using the SHA-1 algorithm as specified in FIPS PUB 180-1. The stored raw data is then deleted from the RAM 24 (step 330). The 160 bit output of the SHA-1 is used as the random seed for the generation of x (step 340).

The private key parameter x is then generated from the 160 bit random seed as specified in Appendix 3 of the FIPS PUB 186-1. The public key y is then generated from the private key x using the equation y=g^{x}mod p, in accordance with section 4 of FIPS PUB 186-1.

After the public/private key pair has been generated, the values are stored in Flash memory 26. The camera 10 uses the private key parameter x to generate a digital signature. In addition to the parameter x, every time that a signature is generated, the DSS algorithm requires a randomly or pseudo-randomly generated integer k (0<k<q). It is important to generate a new value of k for each signature. Although the value of k is completely random and does not depend on the camera's private or public key, it influences the value of the generated signature. Consequently, if the value of k is compromised, the camera's private key can be more easily reverse engineered. Furthermore, if the same value of k is used twice to generate two signatures, a hacker can figure out the private key of the camera without even knowing the value of k. So it is imperative that for every signature, a fresh randomly selected 160 bit k value be generated.

In step 64 of FIG. 2, the processor 18 generates the value of k in a manner similar to what was used to generate the x value, but using the actual image data of the captured image rather than a dark image. More specifically, prior to lossy JPEG compression, the raw 8-bit CFA pixel values of the image that are temporarily stored in RAM 24 prior to image processing and compression are concatenated together to form a string of bits. This string is then hashed down to 160 bits using the same SHA-1 algorithm used to hash the image and metadata to create the digital signature. The 160-bit hash value is used as the random seed into an algorithm to generate the random number k, as described in Appendix 3 of the FIPS PUB 186-1. Since JPEG compression is a lossy operation and it is performed on the interpolated data, it is computationally infeasible to figure out the raw CFA values from the compressed file, and hence, this approach results in a random number that is independent of the image file being signed.

In another embodiment, two different digital signatures are included in the image file. The first digital signature is used for image data and metadata (such as the camera aperture setting and the date/time setting) that should never change. The second digital signature is used for metadata that may possibly change, such as copyright owner and audio annotation file. The TIFF tag used to store the digital signature stores these two separate digital signature values. The application in the host computer 12 uses the camera's public key to decrypt both of the hash values, to create hashes from the compressed digital image data and metadata, and to check whether the newly created hashes match the two decrypted hashes. If both sets of hashes match, it is evidence that neither the digital image nor any of the metadata has been modified since it was captured by the digital camera 10. If the first set of hashes matches, but the second set of hashes does not match, it is evidence that the image has not been modified, but that some of the metadata (e.g., the image copyright owner) has been modified.

In another embodiment, the digital signature can be generated from processed but uncompressed image data and the metadata that is stored in the image file. Alternatively, the digital signature can be generated from the raw image data and the metadata that is stored in the image file. However, since it is preferred to calculate the random number k from the raw image data prior to interpolation, an alternative method for generating k is necessary when the digital signature is generated from the raw image data. For example, data from the image sensor that is not used in the image, such as dark reference pixels, could be used for the computation of k.

The invention has been described in detail with particular reference to certain preferred embodiments thereof, but it will be understood that variations and modifications can be effected within the spirit and scope of the invention.

### Parts List

10 digital camera
12 host computer
14 lens
15 shutter/aperture
16 image sensor
17 variable gain amplifier
18 processor
20 removable memory card
22 memory card interface
24 random access memory (RAM)
26 Flash memory
28 liquid crystal display (LCD)
30 user input buttons
32 host computer interface
33 analog-to-digital converter
34 computer mother board
36 display monitor
38 keyboard and mouse
40 hard drive
42 CD-ROM drive
44 CD-ROM disc
46 interface
48 memory card reader

What is claimed is:

1. In a digital camera of the type employing a private key to encrypt a hash of a digital image captured by the digital camera to produce an image authentication signature, the improvement comprising:
(a) a processor located within the digital camera for generating a random seed entirely from sensor noise within the digital camera and for using the random seed to generate a private key and a public key; and
(b) means for storing the private key in a memory in the digital camera for subsequent use in encryption of the hash of the digital image to produce the image authentication signature.

2. The digital camera claimed in claim 1, further including an image sensor for capturing images, and wherein the processor includes means for producing a random seed for the private key by processing an image captured from the image sensor so that the random noise level in the captured image is used in producing the random seed.

3. The digital camera according to claim 2, further including:
(i) a variable gain amplifier coupled to the image sensor;
(ii) an analog-to-digital converter coupled to the variable gain amplifier and the processor for producing digital signals corresponding to the captured images; and
(iii) the processor causing the variable gain amplifier to be in a high gain condition when the initial test image is captured.

4. The digital camera claimed in claim 1, wherein the processor includes one or more algorithms for producing the random seed, wherein the random seed is used to produce a random number k, and for using the random number k to create the image authentication signature by hashing the raw image data prior to image processing.

5. The digital camera claimed in claim 4, wherein the processor includes an image processing algorithm which uses JPEG compression.

6. In a method of producing an image authentication signature in a digital camera employing a private key to encrypt a hash of an image captured by the digital camera, the improvement comprising the steps of:
(a) generating a random seed entirely from sensor noise in the digital camera and using the random seed to generate a private key; and
(b) storing the private key in a memory in the digital camera for subsequent encryption of the hash of the digital image.

7. A method of authenticating an image captured by a digital camera, comprising the steps of:
(a) generating a random seed entirely from sensor noise in the digital camera and using the random seed to generate a private key and a public key;
(b) storing the private key in a memory in the digital camera;
(c) communicating the public key to a user;
(d) capturing a digital image;
(e) hashing the captured digital image in the digital camera to produce an image hash;
(f) encrypting the image hash in the digital camera with the private key to produce a digital signature; and
(g) authenticating the digital image by hashing the image outside of the digital camera, decrypting the digital signature using the public key to produce a decrypted signature, and comparing the decrypted signature with the image hash produced outside of the digital camera.

8. A method of manufacturing a digital camera capable of producing a digital signature useful for image authentication, comprising the steps of:
(a) manufacturing a digital camera with an internal processor for generating a random seed entirely from sensor noise within the digital camera and using the random seed to generate a private key and a public key, storing the public key in a memory in the digital camera and communicating the public key to a camera operator;
(b) sending the digital camera to an authentication service;
(c) activating the digital camera at the authentication service to produce the private key and public key, and registering the public key at the authentication service; and
(d) sending the digital camera to a user.

9. In a digital camera of the type employing a private key to encrypt a hash of a digital image captured by the digital camera to produce an image authentication signature and a metadata signature corresponding to one or more metadata values, the improvement comprising:
(a) a processor located within the digital camera for generating a random seed entirely from sensor noise within the digital camera and for using the random seed to generate a private key and a public key; and
(b) means for storing the private key in a memory in the digital camera for subsequent use in encryption of the hash of the digital image to produce the image authentication signature and the metadata signature.

10. A method of producing an image authentication signature in a digital camera, comprising the steps of:
(a) capturing a digital image;
(b) compressing the captured digital image;
(c) generating a random seed entirely from sensor noise in the digital camera and for using the random seed to generate a private key and a public key;
(d) storing the private key in a memory in the digital camera;
(e) providing one or more metadata values;
(f) hashing the compressed captured digital image and at least one of the metadata values to produce an image hash; and
(g) encrypting the image hash to produce the image authentication signature.

11. The method according to claim 10 further including the step of storing in an image file in the digital camera, the image authentication signature, the compressed digital image data, and the one or more metadata values.

12. The method according to claim 10 wherein the encrypting step includes encrypting the image hash with a private key produced in the digital camera to produce the image authentication signature.

13. The method according to claim 10 wherein the encrypting step includes encrypting the image hash with the private key to produce the image authentication signature; and further including the step of:
authenticating the captured digital image by hashing the compressed digital image outside of the digital camera, decrypting the image authentication signature using the public key to produce a decrypted signature, and comparing the decrypted signature with the image hash produced outside of the digital camera.

14. The method according to claim 10 further including the steps of: hashing the uncompressed captured digital image to produce a random number k; and wherein the encrypting step includes using the random number k to produce the image authentication signature.

15. The method according to claim 10 wherein the encrypting step further produces a metadata signature corresponding to the one or more metadata values.

16. The digital camera according to claim 1, further including firmware memory, wherein the private key is produced using an algorithm stored in the firmware memory and wherein the algorithm is deleted from the firmware memory after the private key is generated.

17. The method according to claim 6, wherein the private key is produced using an algorithm stored in firmware memory in the digital camera, and wherein the algorithm is deleted from the firmware memory after the private key is generated.

18. The method according to claim 7, wherein the private key is produced using an algorithm stored in firmware memory in the digital camera, and wherein the algorithm is deleted from the firmware memory after the private key is generated.

19. The method according to claim 8, wherein the private key is produced using an algorithm stored in firmware memory in the digital camera, and wherein the algorithm is deleted from the firmware memory after the private key is generated.

20. The digital camera according to claim 9, further including firmware memory, wherein the private key is produced using an algorithm stored in the firmware memory and wherein the algorithm is deleted from the firmware memory after the private key is generated.

21. The method according to claim 10, wherein the private key is produced using an algorithm stored in firmware memory in the digital camera, and wherein the algorithm is deleted from the firmware memory after the private key is generated.

22. In a digital camera of the type employing a private key to encrypt a digital image captured by the digital camera to produce an image authentication signature, the improvement comprising:
(a) a processor located within the digital camera for generating the private key from a physically random process entirely based on sensor noise within the digital camera; and
(b) means for storing the private key in a memory in the digital camera for subsequent use in encryption of the digital image to produce the image authentication signature.

23. The digital camera claimed in claim 22, further including an image sensor for capturing images, and wherein the physically random process is dependent upon a random seed produced from a random noise level in a captured image.

24. The digital camera claimed in claim 23 wherein the random noise level is produced by random dark field image data taken from the sensor.

25. The digital camera according to claim 24, further including:
(i) a variable gain amplifier coupled to the image sensor;
(ii) an analog-to-digital converter coupled to the variable gain amplifier and the processor for producing digital signals corresponding to the captured images; and
(iii) the processor causing the variable gain amplifier to be in a high gain condition when the random dark field image data is captured.
